(19) United States
(12) Patent Application Publication
(10) Pub. No.: US 2003/0171856 A1
(43) Pub. Date: Sep. 11, 2003

(54) Global positioning system readout of recommended altitude in aircraft landing pattern

(76) Inventor: Herbert S. Wilf, Narberth, PA (US)

Correspondence Address: DARBY & DARBY P.C., 805 Third Avenue, New York, NY, 10022, US

(21) Appl. No.: 10/094,008

(22) Filed: Mar. 7, 2002

(51) Int. Cl. G05D 1/00

(52) U.S. Cl. 701/16; 701/4; 340/947; 73/178 T

(57) ABSTRACT

A method and system for determining a desired altitude for an aircraft during descent toward a runway is provided. The method and system utilize latitude and longitude data provided by a global positioning system (GPS) as well as coordinate data concerning the location of a touchdown point. Elevation data concerning the elevation above mean sea level of the touchdown zone of a runway on which the aircraft is to land is utilized in the exemplary embodiment. The method and system of the invention determine a desired altitude for the aircraft without regard to the actual altitude of the aircraft. Instead, the data utilized provide a pilot with recommended altitude data that can be used to maintain a course of approach to the runway at a prescribed angle.

### FIELD OF THE INVENTION

The present invention generally relates to airplane navigation and, more particularly, relates to altitude guidance provided throughout an aircraft's descent and landing pattern.

### BACKGROUND OF THE INVENTION

Global Positioning System (“GPS”) instruments have had, in recent years, enormous impact on the navigation of aircraft, enabling enroute and terminal procedures with the highest precision. The two dimensional position guidance that a GPS offers is of stunning accuracy. The latitude and longitude of an aircraft in flight can now be determined within a few feet, anywhere on earth. The third coordinate of the aircraft, its altitude, is the subject of this patent application, for it has not been adequately addressed by existing systems.

A GPS in and of itself can determine altitude only with a very large error, on the order of a few hundred feet. One reason is because a GPS computes altitude by using a mathematical model of the shape of the earth, and that model is quite imperfect. Hence on a precision approach in instrument conditions, or even on a normal visual approach to a runway, the pilot determines the altitude of the aircraft by using its altimeter, which is most often a barometric device, but which is sometimes based on radar.

It is traditional in aviation that pilots are instructed to “fly the needle.” What this means is that as a pilot approaches a certain navigational beacon, if he is off-course to the right, for instance, a needle on his navigation readout will appear deflected to the left. So the pilot flies the airplane as the needle indicates, in this case to the left, in order to get back on course. The same is true with altitude guidance. If an aircraft is on an instrument landing system (“ILS”) approach to landing, and if its altitude is, say, higher than it should be, a needle on a navigational instrument in the aircraft will appear to be deflected downwards. Hence the correct action for the pilot is to fly as the needle indicates, namely downwards, so the pilot will increase the rate of descent in order to get back on the correct altitude profile.

In both cases, the simple mantra “fly the needle” yields the correct compensating response for the pilot. Since this approach has been successful for so many years, GPS manufacturers have carried it over to this new medium. On a GPS display there are course-deviation electronic “needles” that deflect in just the same way as the traditional ones, and which give pilots right or left course modification instructions by their visual appearance of deflection to the right or the left of their neutral position.

In the case of position guidance, as opposed to altitude guidance, this philosophy has been quite successful and is well accepted by pilots. The GPS knows your position and it also can be programmed to know what your position ought to be, both with great accuracy, and therefore it can advise you about how to steer the aircraft in order to get back on the correct course.

However, in the case of altitude guidance, the “fly the needle” philosophy can be only partially and inaccurately implemented using conventional GPS. If an aircraft is up at cruise altitude and is approaching the point near its destination where it ought to start descending, its GPS can advise it of that fact, and modem ones do. This is because even though GPS altitude is very imprecise, as noted above, this application is not a critical one. An error of even a few hundred feet in advising an aircraft that is up at, say, 10,000 feet, to start its landing approach is of little or no consequence, and similarly, that kind of an error in advising the aircraft about its rate of descent during the descent is of little or no consequence, as long as the aircraft is well above the ground. It is customary, therefore, for current GPS's to advise aircraft of the suggested descent profile only while the aircraft is above, say, 2000 feet altitude. The GPS shows a simulated needle deflection. If the needle is deflected up, the aircraft is too low and the pilot descends at a slower rate, whereas if it is deflected down, the aircraft is too high and the pilot descends faster. In both case he “flies the needle.” That works until the aircraft is at some moderately low altitude, say 2000 feet, at which point most GPS's cease giving any altitude guidance at all because the inherent errors can no longer be tolerated so near the ground.

There is another alternative, however, that has not been used by the GPS industry, seemingly because the industry is closely wed to the philosophy of flying the needle. The philosophy of flying the needle, if applied to altitude, would require the GPS to know your present altitude very exactly, to know your desired altitude very exactly, and to display to you an indication of the difference in the form of a deflected needle. That cannot be done because the GPS does not know your present altitude, unless it is coupled to your altimeter, and only the most sophisticated GPSs have that capability. What is needed in the art is an improved GPS that provides altitude guidance to a touchdown point on a runway, free of the need for a coupling to an aircraft's altimeter. The present invention satisfies this and other needs.

### SUMMARY OF THE INVENTION

The present invention provides a methodology for determining an altitude that is appropriate for an aircraft in order for the aircraft to approach a prescribed touchdown point at an angle that is not too steep or too gradual. Rather, a preferred angle on the order of about 3.0 degrees is, by convention, a preferred angle of approach, and the inventive methodology assists a pilot in achieving this angle of approach without knowledge of the actual altitude of the aircraft. Instead, latitude and longitude data are utilized in conjunction with the elevation of the particular runway at which the plane is to land, to provide the pilot with a desired altitude at which the aircraft should be in order to maintain a course of approach at the preferred or prescribed angle.

In a practical application of the invention, a pilot can compare this desired altitude determination to an accurate altimeter on-board the aircraft and make adjustments as desired.

In one aspect of the invention, a method for advising a pilot of a desired altitude during an aircraft descent toward a prescribed runway at which the aircraft is to land is described. The method is utilized in a global positioning system (“GPS”). The method includes the steps of retrieving touchdown data from a database for the prescribed runway and a latitude and a longitude coordinate of a present global position P of the aircraft. The touchdown data includes a touchdown point T and an elevation E of the touchdown point. Using this retrieved information, the method determines a desired altitude A for the aircraft at its present global position P. The desired altitude is an altitude for the aircraft that places the aircraft on an approach to the prescribed runway at a predetermined angle relative to the touchdown point T and the elevation E. The desired altitude A is output to a display of the GPS system.

In a separate aspect of the method of the present invention, the determination of the desired altitude A includes the steps of computing the distance D, multiplying the distance D by the tangent of the predetermined angle to determine a height H, and adding the elevation E of the touchdown zone of the selected runway (TDZE) to the height. Optionally, the height can be scaled to a desired measurement unit prior to adding the elevation E to the height H.

In yet another aspect of the method of the present invention, the desired altitude A is output to a display of the GPS system only after confirming that a course deviation is within a prescribed tolerance.

The invention also includes a module that operates with a GPS system to determine a desired altitude for an aircraft. The module includes a program executing in the GPS system, and which has access to the information stored in the database of the GPS. The database contains information retrievable on the basis of a selected airport and runway. That information includes touchdown point data comprising latitude and longitude coordinates for any given selected airport and runway. The program is configured to determine a desired altitude at a given position P of an aircraft relative to the touchdown point stored in the database of the selected airport and runway. In a preferred form, the database is further provided with elevation data that is associated with each touchdown point data and the program configured to determine the desired altitude using the elevation data as well as the touchdown point data.

These and other aspects, features and arrangements of the invention can be appreciated from the accompanying Drawing Figures and Detailed Description of an Exemplary Embodiment.

### DETAILED DESCRIPTION OF AN EXEMPLARY EMBODIMENT

By way of overview and introduction, if you are the pilot of an aircraft that is descending for a landing, it is very desirable to maintain the correct rate of descent until touchdown. This is true whether you are flying in instrument meteorological conditions (IMC), i.e., you cannot see the runway that you will be landing on or when the target airport is visible. To maintain the correct rate of descent, a pilot must be at the correct altitude in relation to the distance from a touchdown point T.

As used herein, “altitude” refers to the linear distance above mean sea level, and is used in the contexts of an actual altitude of an airplane as indicated by an altimeter within the cockpit of the plane and a desired altitude determined by the module and method of the present invention.

Also, as used herein, “height” refers to the linear distance above a specific point on earth, for example, a touchdown point on a runway. The term “elevation” refers to the linear distance above mean sea level of a specific point on earth, for example, the elevation of the touchdown zone (“TDZE”) of a given runway.

In FIG. 3, the aircraft is at point P, and its height relative to the touchdown point is H. The plane will touch down at point T, and during its descent it should stay on the line joining P and T, which is at a prescribed angle relative to the horizontal, and which preferably is at an angle of 3 degrees with the horizontal.

On a high-quality instrument landing system (“ILS”) approach, altitude guidance is given to the pilot by a glideslope beam. An indicator on the instrument panel of the airplane responds to the glideslope beam and shows whether the pilot is above, below, or on an imaginary line that meets the point T at, say, a 3-degree angle. If the aircraft is much above that line the descent will be too steep and an overrun of the runway might result. If the aircraft is much below that line, the approach will be too horizontal with little opportunity for a soft landing. Only a modest portion of United States airports is equipped with such an ILS.

However, if an aircraft is landing at an airport that does not have an ILS, such as one of the numerous regional airports around the United States and its territories, then there are perhaps two possibilities. In visual meteorological conditions (“VMC”), if the airport is equipped with a VASI device, then the pilot will see, throughout the descent, a red light next to the runway if he is too low, a white light if he is too high, and an orange light if he is at the right altitude. What remains, however, are the numerous situations in which either the airport does not have a VASI device, or the pilot cannot see it because he is in IMC, in which case altitude guidance is not available. How then should the pilot maintain the correct altitude on descent?

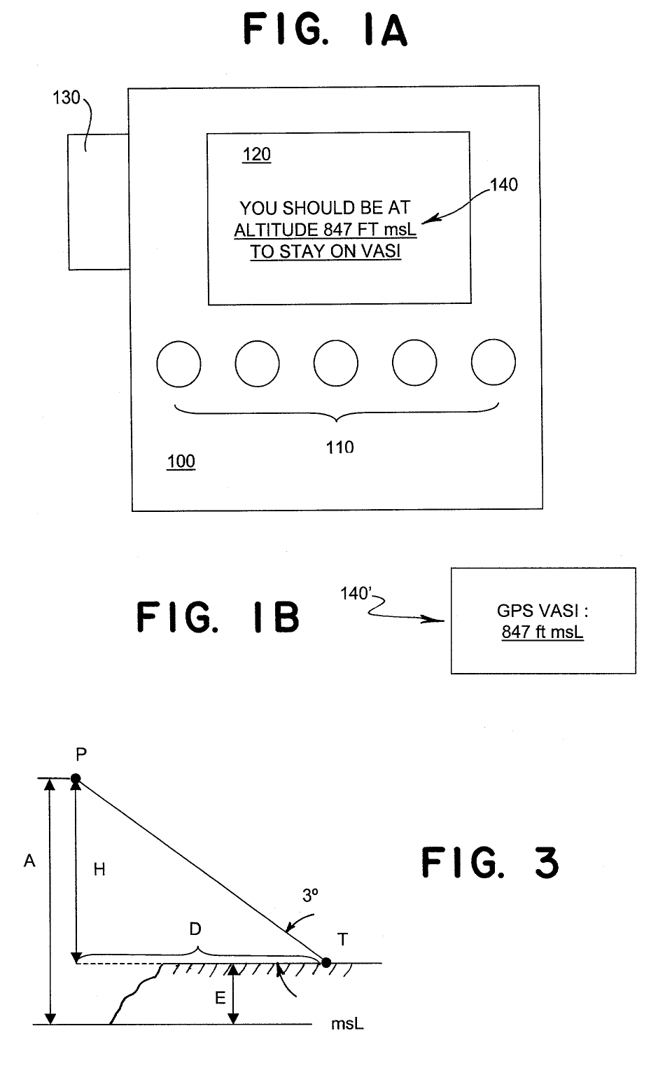

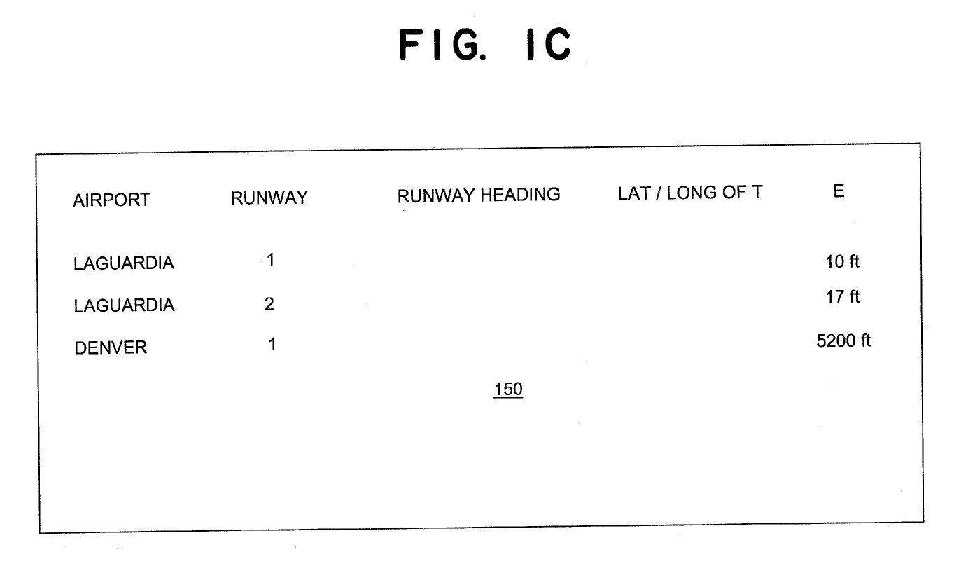

Referring now to FIG. 1A, a GPS 100 is shown. The GPS 100 has input devices shown as buttons 110. Instead of or in addition to buttons, the GPS can include a touch-sensitive screen or pen-activated input panel as is conventional on personal digital assistants commercially available from the Palm Corporation (e.g., the Palm Pilot), Compaq, Microsoft, and others. The GPS includes a display panel 120 that outputs latitude and longitude information, as is conventional, as well as desired altitude data in accordance with the exemplary embodiment. The GPS 100 includes a data card port shown fitted with an altitude software module (ASM) 130 configured to implement the exemplary embodiment when the altitude software of the module 130 is executing in the host GPS 100. The ASM 130 can be embodied in other forms that permit execution within the GPS 100 rather than a data card, as understood by those of skill in the art.

The altitude software module (ASM) 130 causes the GPS 100 to display on the display panel 120 a desirable altitude for the aircraft at any point during its approach to landing in the form of a digital display of the recommended altitude, in feet MSL, rather than in the form of a deflected needle. In FIG. 1A, the desirable altitude is displayed in a portion 140 of the display panel as a recommendation: “You should be at altitude 847 ft MSL to stay on VASI.” Alternatively, portion 140′ might more pointedly display “GPS-VASI: 847 ft MSL,” as shown in FIG. 1B.

The determination of a recommended altitude of, say, 847 feet MSL, is achieved in the exemplary embodiment using three pieces of information, namely:

1. the present position of the aircraft, which the GPS 100 knows very accurately,

2. the position of the intended point of touchdown on the runway, which the ASM 130 knows from tabulated data with essentially zero error, and

3. the elevation of the intended point of touchdown, which the ASM 130 also knows from tabulated data with essentially zero error.

Using only position information, the ASM 130 can advise a pilot throughout a descent of the aircraft a desirable altitude for the aircraft, with great precision and without reliance upon altitude computations by the host GPS 100. Thus, using only position information, none of which involves knowing the actual altitude of the aircraft, the ASM 130 computes the altitude above MSL of an imaginary glideslope line for the current position of the aircraft and displays that altitude digitally (in portion 140 or 140′) to the pilot. Since there is no “deflected needle” for altitude, the pilot looks at the recommended altitude provided by the ASM 130 and looks at the actual altitude measured by his aircraft's altimeter and decides whether to increase or decrease his rate of descent. This is not very much of a mental exercise, and the added labor of comparing the two figures can be done very easily and rapidly. In exchange for giving up the deflected needle display and replacing it by a readout of recommended altitude, altitude guidance system results that have the full precision of GPS position, with none of the errors inherent in the use of GPS altitude.

With reference to FIG. 1C, a database 150 resident in or accessible by the ASM 130 relates particular airports and their runways with runway vectors (i.e., the orientation of the runway), a latitude and longitude coordinate of the touchdown point T of each runway, and the TDZE (preferably in feet above or below mean sea level). Airport and runway designations made by the pilot using the buttons 110 cause the ASM 130 to access the database 150 and retrieve the runway vector, T coordinates, and elevation data for a given airport and runway.

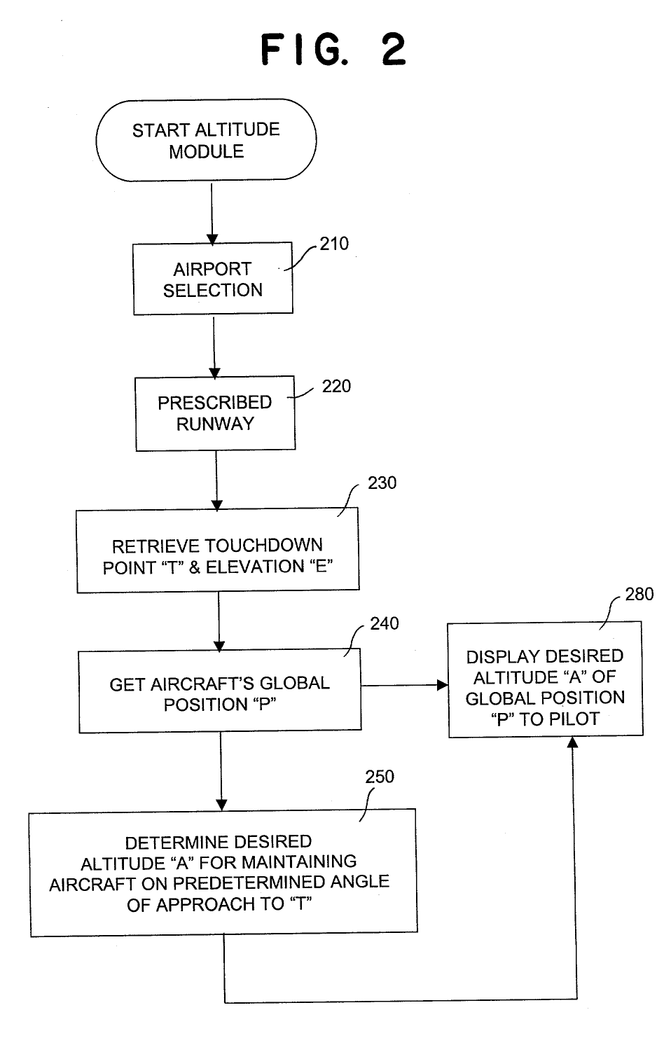

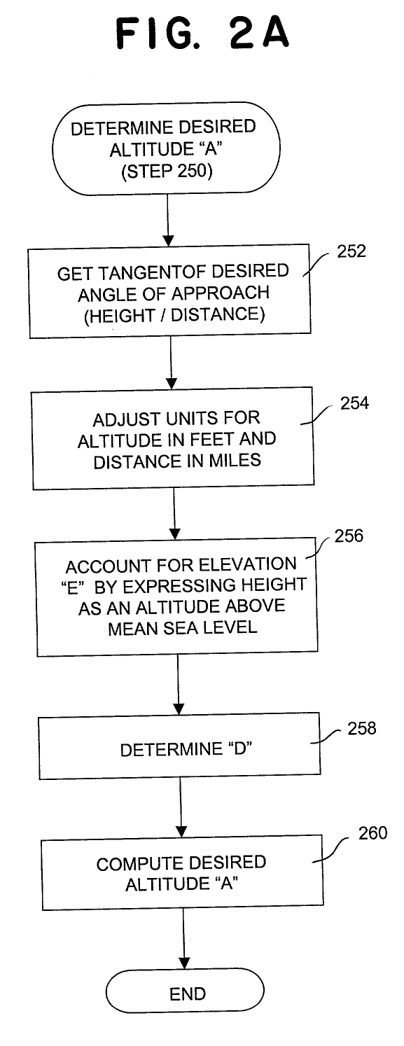

An exemplary method for advising a pilot of a desired altitude during a descent is now described with reference to FIG. 2. At step 210, the pilot enters an airport selection using the buttons 110. This may comprise interaction with a selection list or direct entry of the name or code (e.g. “KLAG” for LaGuardia) of the airport. Preferably, if direct entry is used, the entered characters cause a default name to appear for selection, which name selection is refined as further characters are entered until unambiguously identified.

Ordinarily, a runway is not assigned to the pilot until some minutes before touchdown. Typically one can hear the wind direction, if the landing will be at a small airport, when about 30 miles from landing, and then the pilot will know which runway to use and will be able to select a runway and enter the so-selected runway as a prescribed runway at step 220. For an airport with a tower, the pilot will hear the broadcast of the ATIS (field conditions) about 50-60 miles from landing, and will know which runway to enter at step 220. On an instrument approach, the controller will explicitly tell the pilot “Expect VOR Approach 27 Left”, for instance, which tells the pilot to expect runway 27Left, about 10-15 minutes before landing and, again, this runway can then be entered at step 220.

At step 230, the ASM 130 retrieves the touchdown point for that runway by accessing the database 150. The ASM 130 can access the appropriate touchdown point T data using the airport and runway entries that were provided at steps 210 and 220. At step 240, the module gets the latitude-longitude position of the aircraft P (latₚ, longₚ) by polling the conventional circuitry of the GPS host machine that is running the altitude software module 130 or by other signal transfer between the host GPS and the ASM 130. From that touchdown point and the lat/long position of the aircraft, both of which the GPS knows, the module 130 proceeds to determine the recommended GPS-VASI altitude at step 250.

Preferably, the ASM 130 displays desired altitude after the bearing from the aircraft to the touchdown point agrees with the runway heading, say, within about 10 degrees on either side. The GPS then starts to advise of recommended GPS-VASI altitude, and the pilot makes corrections to his descent rate so as to stay on the prescribed angle of approach. The aircraft need not be aligned with the runway extension and the desired altitude can be displayed in portion 140, 140′ at step 280 after the desired altitude has been determined at step 250.

With reference now to FIG. 2A, the determination of the desired altitude A in the exemplary embodiment is described. Recall that the pilot has entered the airport and the number of the runway on which a landing is desired into ASM 130. The ASM therefore knows the position of the touchdown point T on that runway. Since the GPS 100 knows the position of the aircraft (P in FIG. 3), and the ASM knows the desired touchdown point (T) coordinates, the ASM 130 can easily compute the distance from the present position of the aircraft to that touchdown point, i.e., the distance D in FIG. 3. Distance D is computed by the GPS 100 in a conventional manner that forms no part of the present invention.

The ASM 130 is preferably programmed to have a prescribed angle of approach such as 3 degrees; however, other angles could be prescribed if desired. Now, simple trigonometry will reveal the correct height H in order to achieve an airplane approach at the desired (prescribed) angle. In fact, the ratio H/D (see FIG. 3) is the tangent of the prescribed angle of approach, which is 0.02541 if the prescribed angle is 3 degrees. At step 252, the ASM retrieves or computes the tangent of the prescribed angle of approach. This means that at all times during the descent it must be true that H=0.05241 D for the preferred angle approach. It is actually convenient to have the height H expressed in feet while the distance D is expressed in miles, since these are the natural units. Accordingly, unit adjustments are made at step 254. Specifically, we multiply by 5280, to discover that H=276.7D with H expressed in feet and D expressed in miles.

Now, in FIG. 3 we note that the height H is measured above ground. But in an aircraft, what the pilot sees is his altitude above mean sea level (MSL). To express this altitude, we must account for the elevation E of the airport runway above MSL by expressing height H as an altitude A, at step 256. This information is easy to incorporate into the databases that accompany GPS's and elevation data is included in the right-most column of database 150 (FIG. 1C).

The final result is that the desired altitude A, of the aircraft, measured in feet above MSL, is expressed in terms of the distance D to the desired touchdown point on the runway, measured in miles, and elevation above mean sea level, measured in feet. Specifically:

A=276.7D+E.

Thus, solving the above equation for a desired altitude A is performed using only position information. The distance D is determined at step 258 using the latitude and longitude coordinates of the aircraft P and touchdown point T in the usual way. Using this D, and with reference to the elevation data in the database 150, the desired altitude based on the aircraft's distance from the touchdown point T can be computed at step 260 as in the following example:

### EXAMPLE

If the aircraft is 5 miles from the intended point of touchdown (D=5), and if the airport elevation is 300 feet MSL, then the desired altitude for that aircraft at that moment is

A=276.7×5+300=1683;

or 1683 feet above MSL.

Accuracy of the Proposed Recommended Altitude Display

The basic relation between the displayed altitude recommendation and the GPS-determined distance is given, as described above, by the relation A=0.05241*D+E also gives insight into the accuracy of the result. Indeed from this relation one sees that the error in the displayed recommended altitude, expressed in feet, is 0.05241 times the error in the distance D, expressed in feet, since the error in the TDZE, E, can be taken to be zero. In currently available GPS's, distances are determined with errors in the neighborhood of 25 feet, now that dithering by the United States Department of Defense has ceased. This means that the display of recommended altitude will typically be subject to an error in the neighborhood of 1.31 feet, i.e., about 16 inches. Thus, even if the distance computation were grossly in error by 100 feet (which is almost unheard of), then the displayed altitude might be in error by less than six feet. This kind of accuracy is very likely to be implementable in a form that would be certifiable by the FAA for use in IMC, to guide instrument approaches other than ILS's, and provide reliable altitude guidance. Hence, we specifically claim the novelty and utility of implementing this display in an instrument meteorological environment, to give altitude guidance in terminal procedures in the categories of VOR, NDB, LDA, and GPS approaches.

Such stellar accuracy provided by the invention is in contrast with, for example, the accuracy that could be expected from a GPS-implemented CDI which would recommend heading changes to stay on a predetermined heading, or direction of flight, say down a runway centerline. A heading is computed from the difference of two or more position readings which are typically very close to each other. Hence there is important loss of significant digits from the subtraction of nearly equal numbers, which degrades the accuracy guarantee that can be given with such a computation and renders it unusable in IMC.

While the invention has been described in connection with an exemplary embodiment thereof, it is not so limited in scope but rather is defined by the recitations in the following claims and equivalents thereof.

I claim:

1. In a GPS system, a method for advising a pilot of a desired altitude during an aircraft descent toward a prescribed runway at which the aircraft is to land, comprising the steps of:
(a) retrieving touchdown data from a database for the prescribed runway including a touchdown point T and an elevation E of the touchdown point;
(b) retrieving a latitude and a longitude coordinate of a present global position P of the aircraft from the GPS system;
(c) determining a desired altitude A for the aircraft at its present global position P that places the aircraft on an approach to the prescribed runway at a predetermined angle relative to the touchdown point T and the elevation E; and
(d) outputting the desired altitude A to a display of the GPS system.

2. The method of claim 1, including additional steps of inputting the prescribed runway and inputting the particular airport at which the aircraft is to land.

3. The method of claim 2, wherein the inputting step is comprised of inputting the number of a runway for the given airport at which the aircraft is to land.

4. The method of claim 1, wherein the database is included on a data card that is configured to connect to a slot of the GPS system.

5. The method of claim 4, wherein steps (a) through (d) are performed by software contained on the data card.

6. The method of claim 1, wherein the determining step is made using only the elevation E and latitude and longitude coordinates of points P and T.

7. The method of claim 6, wherein the determining step comprises the steps of:
computing a distance D between points P and T;
multiplying the distance D by the tangent of the predetermined angle to determine a height H;
adding the elevation E to the height,
whereby a desired altitude A is determined.

8. The method of claim 7, including the additional step of scaling the height to a desired measurement unit prior to adding the elevation E to the height H.

9. The method of claim 8, wherein the scaling step comprises multiplying the distance D by 5280, whereby the height is expressed in units of feet.

10. The method of claim 1, wherein the outputting step is performed only after confirming that a course deviation is within a prescribed tolerance.

11. A module for a GPS system having a database containing information retrievable on the basis of a selected airport and runway, the information in the database including touchdown point data comprising latitude and longitude coordinates for any given selected airport and runway, comprising:
a program executing in the GPS system and configured to determine a desired altitude at a given position P of an aircraft relative to the touchdown point data stored in the database of the selected airport and runway.

12. The module of claim 11, wherein the program is further configured to retrieve information from the database in response to an airport and runway selection entered using input means of the GPS system.

13. The module of claim 11, wherein the database further includes touchdown zone elevation data associated with each touchdown point data and wherein the desired altitude is further determined using the touchdown zone elevation data.
